(19) United States
(12) Patent Application Publication
(10) Pub. No.: US 2010/0048063 A1
(43) Pub. Date: Feb. 25, 2010

(54) MULTI-PURPOSE PLUG

(76) Inventor: Hok Man Lam, Hong Kong (CN)

Correspondence Address: JOHN ALEXANDER GALBREATH, 2516 CHESTNUT WOODS CT, REISTERSTOWN, MD, 21136, US

(21) Appl. No.: 12/525,559

(22) PCT Filed: Jan. 30, 2008
(86) PCT No.: PCT/CN08/00223

§ 371 Date: Aug. 3, 2009

(30) Foreign Application Priority Data
Jan. 31, 2007 (CN) 200720002230.7

(51) Int. Cl. H01R 31/06

(52) U.S. Cl. 439/628

(57) ABSTRACT

This Utility Model is a multi-purpose plug. It includes a pedestal (1) which is used to connect with the electric equipment. Its feature is that it also includes a number of different-typed plug connectors (2) which are detachably connected with the described pedestal (1). This multi-purpose plug includes a number of different types of plug connectors. They are suitable for various sockets thus making them more convenient to use.

### FIELD OF THE UTILITY MODEL

The Utility Model relates to a power plug connector, specifically, is a multi-purpose plug.

### BACKGROUND OF THE UTILITY MODEL

Each country has a different standard for its electrical plugs, thus there are different standard for its sockets that match the plugs. Generally, when a customer buys a electrical plug, it usually adapts to one country only. This may cause a lot of inconvenience. For example, for those international businessmen who often need to work in different countries, if the plugs of the laptops they are carrying may adapt to one country only, their work will be dramatically impacted.

### SUMMARY OF THE UTILITY MODEL

This Utility Model is addressing the disadvantage of the current technology and provides a kind of Multi-purpose plug.

The solution adopted by this Utility Model in addressing the technical issue is: making a kind of multi-purpose plug, including a pedestal which is used to connect with the electric equipment, its feature is that it also includes a number of different-types of plug connectors which are detachably connected with the described pedestal.

In the described multi-purpose plug of this Utility Model, the described pedestal has a slot. On the end of the described plug connector, there is an inserted handle which matches the described slot. It also includes a locking device which fixes the described inserted handle into the described slot.

In the described multi-purpose plug of this utility model, the described locking device includes a box-shaped structure. Inside the described box-shaped structure, there is a bolt tab. A press plug locates on the external part of the described box-shaped structure which corresponds to the described bolt tab. The described press plug is inserted into the described slot and is connected with the described pedestal via a spring. The box-shaped structure of the described press plug is parallel to the plane in which the mouth of the inserted slot sits.

In the described multi-purpose plug of this Utility Model, the described inserted handle has a mounting hole which corresponds to the described bolt tab.

In the described multi-purpose plug of this Utility Model, the described pedestal has an electrical connection device for the pedestal. The described inserted handle has an electrical connection device for the inserted handle which matches the electrical connection device for the described pedestal.

In the described multi-purpose plug of this Utility Model, the described pedestal has a power outlet and a power supply unit.

Implementation of the multi-purpose plug in this utility model has following benefits: the multi-purpose plug in this Utility Model includes a number of different-types of plug connectors. They are suitable for various sockets thus are more convenient to use.

### BRIEF DESCRIPTION OF THE DRAWINGS

The Utility Model is further illustrated by using the attached figures and a practical example. Among the attached figures:

FIG. 1 is the structural sketch of the multi-purpose plug in this Utility Model;

FIG. 2 is the structural sketch of the plug connector in the first implementation method of the multi-purpose plug in this Utility Model;

FIG. 3 is the structural sketch of the plug connector in the second implementation method of the multi-purpose plug in this Utility Model;

FIG. 4 is the structural sketch of the plug connector in the third implementation method of the multi-purpose plug in this Utility Model;

FIG. 5 to FIG. 7 is the structural sketches showing the process of the inserted plug of the plug connector of the multi-purpose plug in this Utility Model being inserted into the pedestal;

FIG. 8 is the sectional view of the plug connector of the multi-purpose plug in this Utility Model;

FIG. 9 is the sectional view of the locking device of the multi-purpose plug in this Utility Model.

### DETAILED DESCRIPTION OF THE PREFERRED EMBODIMENT

This Utility Model involves a kind of multi-purpose plug. The multi-purpose plug includes a number of different-types of pedestals 1 which are used to connect with the electrical equipment and a number of different-typed plug connectors 2 which are detachably connected with pedestals 1.

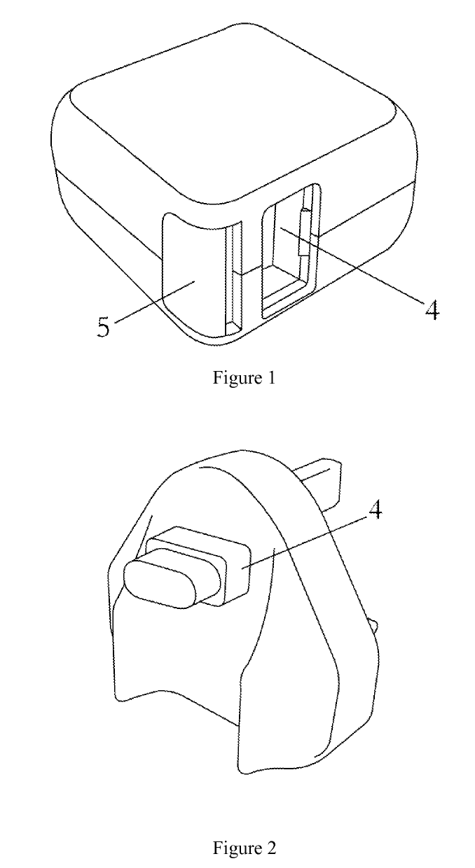

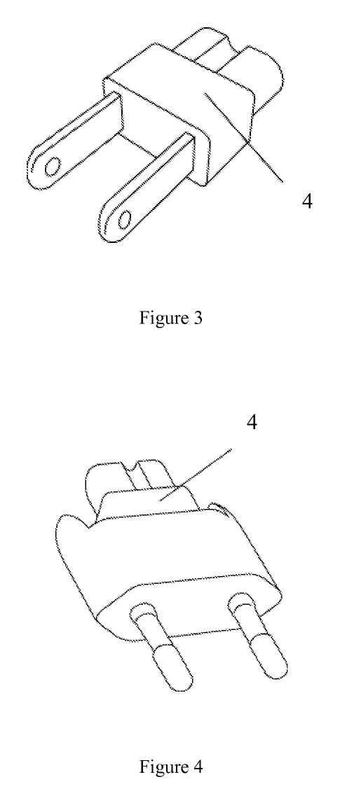

FIG. 1 is the structural sketch of the pedestal of the multi-purpose in this Utility Model. FIG. 2 is the structural sketch of the plug connector in the first implementation method. This plug connector is commonly seen in UK. FIG. 3 is the structural sketch of the plug connector in the second implementation method. This plug connector is commonly used in North America and Japan. FIG. 4 is the structural sketch of the plug connector in the third implementation method. This plug connector is commonly used in Korea. The Multi-purpose plug in this Utility Model can be used in different countries.

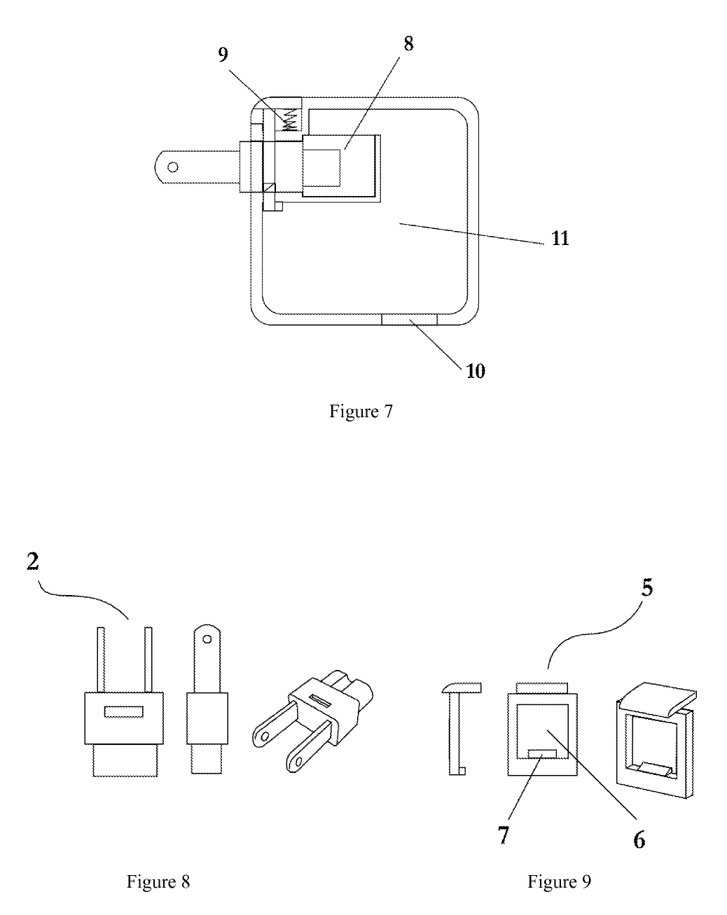

FIG. 8 is the sectional view of the plug connector of the multi-purpose plug in this Utility Model. FIG. 9 is the sectional view of the locking device of the multi-purpose plug. The combined FIG. 8 and FIG. 9 describe the way of connection between the plug connector and the pedestal in this Utility Model. In them, the described pedestal 1 has a slot 3. There is an inserted handle 4 at the end of the plug connector 2 which corresponds to the described Slot 3. The inserted handle 4 has a mounting hole 12 which corresponds with the described bolt tab 7. Pedestal 1 has an electrical connection device 8 for the pedestal. The described inserted handle 4 has an electrical connection device for the inserted handle which matches the electrical connection device 8 for the described pedestal. The described pedestal 1 has a power outlet 10 and a power supply unit 11. A locking device 5 is also included which fixes the described inserted handle 4 into the described slot 3. FIG. 9 is the structural sketch of the locking device 5. This locking device 5 includes a box-shaped structure 6. Inside the described box-shaped structure 6, there is a bolt tab 7. The external part of the described box-shaped structure which corresponds to the described bolt tab 7 has a press plug. The described press plug is inserted into the described slot 3 and is connected to the described pedestal 1 via spring 9. The box-shaped structure 6 of the described press plug is parallel to the plane in which the mouth of the described slot 3 sits.

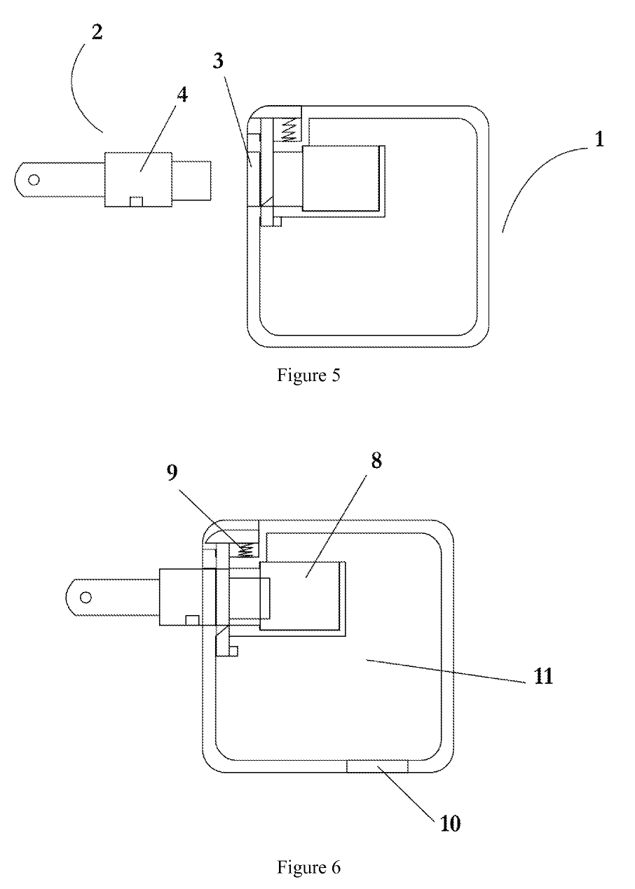

FIG. 5 to FIG. 7 are the structural sketches showing the process of the plug connector of the multi-purpose plug in this Utility Model being inserted into the pedestal. The combined figures describe the way the plug connector is fixed into the pedestal. While the plug connector 2 is inserted into the slot 3 of the pedestal 1, the bolt tab 7 is pressed down thus the entire locking device 5 is pressed down. After fully inserted, the locking device 5 will restore to its original position under the elasticity of the spring 9. The bolt tab 7 will be locked in the mounting hole 12 of the bolt tab 7 and tightly lock the plug connector 2.

While pulling out, first press the press plug down, making the bolt tab 7 retreat from the mounting hole 12, then pulling the plug connector 2 out.

1. A multi-purpose plug, including a pedestal (1) which is used to connect with the electric equipment. Its feature is that it also includes a number of different-types of plug connectors (2) which are detachably connected with the described pedestal (1).

2. According to claim 1 of the described multi-purpose plug, its feature is that the described pedestal (1) has a slot (3). On the end of the described plug connector (2), there is an inserted handle (4) which matches the described slot (3). It also includes a locking device (5) which fixes the described inserted handle (4) into the described slot (3).

3. According to claim 1 of the described multi-purpose plug, its feature is that the described locking device (5) includes a box-shaped structure (6). Inside the described box-shaped structure (6), there is a bolt tab (7). A press plug locates on the external part of the described box-shaped structure (6) which corresponds to the described bolt tab (7). The described press plug is inserted into the described slot (3) and is connected with the described pedestal (1) via a spring (9). The sox-shaped structure (6) of the described press plug is parallel to the plane in which the mouth of the described slot (3) sits.

4. According to claim 1 of the described multi-purpose plug, its feature is that the described inserted handle (4) has a mounting hole (12) which corresponds to the described bolt tab (7).

5. According to any one of the claims 1-4 of the described multi-purpose plug, its feature is that the described pedestal (1) has an electrical connection device (8) for the pedestal. The described inserted handle (4) has an electrical connection handle for the inserted handle which matches the electrical connection device (8) for the described pedestal.

6. According to any one of the claims 1-4 of the described multi-purpose plug, its feature is that the described pedestal (1) has a power outlet (10) and a power supply unit (11).
